(19) United States
(12) Patent Application Publication
(10) Pub. No.: US 2016/0083630 A1
(43) Pub. Date: Mar. 24, 2016

(54) Composition for Pressure-Sensitive Adhesive and Pressure-Sensitive Adhesive Sheet

(71) Applicant: SOKEN CHEMICAL & ENGINEERING CO., LTD., Tokyo (JP)

(72) Inventors: Kaoru Suda, Sayama-shi (JP); Tetsuya Yoshida, Sayama-shi (JP)

(21) Appl. No.: 14/892,230

(22) PCT Filed: Apr. 30, 2014
(86) PCT No.: PCT/JP2014/061983

§ 371 Date: Nov. 19, 2015

(30) Foreign Application Priority Data
May 28, 2013 (JP) 2013-111685

(51) Int. Cl. C09J 133/08; C09J 7/02

(52) U.S. Cl. CPC C09J 133/08; C09J 7/0217; C09J 2433/00; C09J 2201/606; C09J 2467/006

(57) ABSTRACT

A composition for a pressure-sensitive adhesive, includes (A) a (meth)acrylic ester polymer having a trithiocarbonate structure, having hydroxyl groups at both ends of a molecule and having a weight-average molecular weight (Mw), as measured by gel permeation chromatography, of 50,000 to 300,000, and (B) an isocyanate compound having an average number of isocyanate groups in one molecule being more than 2.

### TECHNICAL FIELD

The present invention relates to a composition for a pressure-sensitive adhesive, the composition including a (meth)acrylic ester polymer having hydroxyl groups at both ends and an isocyanate-based crosslinkling agent, and a pressure-sensitive adhesive sheet having a pressure-sensitive adhesive layer formed of the composition.

### BACKGROUND ART

In the field of pressure-sensitive adhesives, stable performance and handling properties under more severe durability conditions have been desired in recent years. This tendency is the same as that of low staining properties on an adherend in the removal of a pressure-sensitive adhesive sheet under the conditions from low temperature to high temperature.

However, it has been generally difficult to reduce staining on an adherend in the removal of a pressure-sensitive adhesive sheet while maintaining a balance of basic properties of pressure-sensitive adhesives, such as adhesive strength, holding power and constant load properties. For example, an acrylic polymer contained in a conventional composition for a pressure-sensitive adhesive has a weight-average molecular weight (Mw) of 500,000 to 1,500,000, and when an isocyanate-based crosslinking agent is added to this acrylic polymer to control performance, low-molecular weight components remain, so that these residual components migrate to the surface of the pressure-sensitive adhesive layer with time or under the heat-resistant conditions and cause staining.

On the other hand, a field in which various acrylic polymers have been proposed is not limited to the field of pressure-sensitive adhesives.

In a patent literature 1, there is described a RAFT polymer obtained by subjecting a vinyl monomer to Reversible Addition-Fragmentation chain Transfer (RAFT) polymerization using, as a stating substance, a RAFT polymerization agent that is obtained by a RAFT polymerization method using a dibenzyl trithiocarbonate derivative having hydroxyl groups at both ends. Further, a polymer obtained by allowing a hydroxyl group of this RAFT polymer to react with a diisocyanate compound is described.

In the patent literature 1, however, study of using, as a pressure-sensitive adhesive, the polymer obtained by allowing a hydroxyl group of the above RAFT polymer to react with a diisocyanate compound has not been particularly carried out.

In a patent literature 2, a curable composition containing a (meth)acrylic polymer having a hydroxyl group at an end and a compound having at least 2 functional groups capable of reacting with a hydroxyl group, such as a polyvalent isocyanate compound, is described.

In the patent literature 2, the number-average molecular weight (Mn) of a polymer obtained in the working example is not more than 10,000, and this polymer has been crosslinked. However, it is thought that in order to use the thus obtained material as a pressure-sensitive adhesive, the distance between crosslinking points of the resulting crosslinked product is too short.

In a patent literature 3, there is described a method for increasing a molecular weight of a polyacrylate, including allowing a polyacrylate, in which a chain end has been functionalized with an appropriate group X, to react with a compound X having, together with the above functional group X, at least 2 functional groups Y capable of participating in the connection reaction that is in the form of addition or substitution reaction. It is also described that the polyacrylate obtained in this method is used as a pressure-sensitive adhesive.

However, in order to form a pressure-sensitive adhesive having basic properties of pressure-sensitive adhesives, such as adhesive strength, holding power and constant load properties, and having a low degree of staining on an adherend in the removal of a pressure-sensitive adhesive sheet, further improvement in constitution of an acrylic polymer, a crosslinking agent and others is necessary.

### CITATION LIST

### Patent Literature

Patent literature 1: Japanese Patent Laid-Open Publication No. 2011-052057

Patent literature 2: Japanese Patent Laid-Open Publication No. 1999-080249

Patent literature 3: Japanese Translation of PCT International Application Publication No. 2005-510597

### SUMMARY OF INVENTION

### Technical Problem

The present invention addresses the problem of providing a composition for a pressure-sensitive adhesive, the composition being capable of forming a pressure-sensitive adhesive that has basic properties of pressure-sensitive adhesives, such as adhesive strength, holding power and constant load properties, and reduces staining on an adherend when a pressure-sensitive adhesive sheet is removed.

### Solution to Problem

In order to solve the above problem, the present inventors have earnestly studied. As a result, they have found that the above problem can be solved by a composition for a pressure-sensitive adhesive, including a specific (meth)acrylic ester polymer and an isocyanate compound having an average number of isocyanate groups in one molecule being more than 2, and they have completed the present invention.

The present invention is, for example, any of the following [1] to [6].

[1] A composition for a pressure-sensitive adhesive, comprising (A) a (meth)acrylic ester polymer having a structure represented by the later-described formula (a1), having hydroxyl groups at both ends of a molecule and having a weight-average molecular weight (Mw), as measured by gel permeation chromatography, of 50,000 to 300,000, and (B) an isocyanate compound having an average number of isocyanate groups in one molecule being more than 2.

[2] The composition for a pressure-sensitive adhesive as stated in the above [1], wherein the molecular weight distribution (Mw/Mn) of the (meth)acrylic ester polymer (A) is 1 to 3.5.

[3] The composition for a pressure-sensitive adhesive as stated in the above [1] or [2], wherein the (meth)acrylic ester polymer (A) is a RAFT polymer represented by the later-described formula (A1-1).

[4] The composition for a pressure-sensitive adhesive as stated in any one of the above [1] to [3], wherein the (meth)acrylic ester polymer (A) is at least one kind selected from a RAFT polymer represented by the later-described formula (A2-1) and a RAFT polymer represented by the later-described formula (A3-1).

[5] The composition for a pressure-sensitive adhesive as stated in any one of the above [1] to [4], wherein the (meth)acrylic ester polymer (A) and the isocyanate compound (B) are contained in such amounts that the total amount of isocyanate groups of the compound (B) based on 1 mol of an end hydroxyl group of the polymer (A) becomes 1 to 100 mol.

[6] A pressure-sensitive adhesive sheet having a substrate and a pressure-sensitive adhesive layer formed of the composition as stated in any one of the above [1] to [5].

### Advantageous Effects of Invention

According to the present invention, a composition for a pressure-sensitive adhesive, the composition being capable of forming a pressure-sensitive adhesive that has basic properties of pressure-sensitive adhesives, such as adhesive strength, holding power and constant load properties, and reduces staining on an adherend when a pressure-sensitive adhesive sheet is removed, can be provided. Further, the composition can form a pressure-sensitive adhesive having small dependence of peel force on peel rate and small dependence of peel force on peeling temperature.

### DESCRIPTION OF EMBODIMENTS

The composition for a pressure-sensitive adhesive, the pressure-sensitive adhesive and the pressure-sensitive adhesive sheet according to the present invention are described hereinafter.

In the present specification, the term “polymer” is intended to include homopolymer and copolymer, and the term “polymerization” is intended to include homopolymerization and copolymerization.

[Composition for Pressure-Sensitive Adhesive]

The composition for a pressure-sensitive adhesive of the present invention includes a specific (meth)acrylic ester polymer (A) and an isocyanate compound (B) having an average number of isocyanate groups in one molecule being more than 2 (the compound being also referred to as a “polyfunctional isocyanate compound (B)” hereinafter).

Since the composition for a pressure-sensitive adhesive of the present invention has the following constitution, the composition can form a highly functional pressure-sensitive adhesive having basic adhesion properties almost equal to or higher than those of the existing products, having excellent heat resistance and exhibiting low staining properties when a pressure-sensitive adhesive sheet is removed under the conditions from low temperature to high temperature.

<(Meth)Acrylic Ester Polymer (A)>

The (meth)acrylic ester polymer (A) has a structure represented by the formula (a1), has hydroxyl groups at both ends of a molecule and has a weight-average molecular weight (Mw), as measured by gel permeation chromatography, of 50,000 to 300,000.

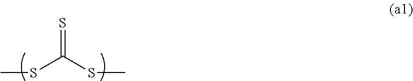

The polymer (A) has a structure represented by the formula (a1) (also referred to as a “trithiocarbonate structure” hereinafter).

The polymer (A) has hydroxyl groups at both ends of a molecule and has Mw/Mn preferably in the later-described range. On this account, it is thought that a crosslinked product (network polymer) formed from the polymer (A) and the compound (B) has a crosslinked structure (network structure) that has a uniform distance between crosslinking points and is free from defects. Therefore, a pressure-sensitive adhesive layer formed of the composition of the present invention has excellent mechanical properties, such as high elasticity and high extensibility.

The weight-average molecular weight (Mw) of the polymer (A), as measured by gel permeation chromatography, is 50,000 to 300,000, preferably 70,000 to 280,000, more preferably 100,000 to 250,000. By the use of the polymer (A) having Mw in the above range, a balance of adhesive strength can be easily kept. If Mw exceeds the upper limit of the above range, the rate of reaction of a hydroxyl group of the polymer (A) with an isocyanate group of the compound (B) is lowered, and crosslinking hardly proceeds. If Mw is less than the lower limit of the above range, staining on an adherend is caused when a pressure-sensitive adhesive sheet is removed.

In a conventional composition for a pressure-sensitive adhesive, Mw of a polymer needs to be not less than 500,000 in order to ensure cohesive force. The reason is that there is a scatter of a molecular weight of the polymer to be crosslinked. On the other hand, the composition for a pressure-sensitive adhesive of the present invention exhibits excellent cohesive force even if Mw of the polymer is not more than 300,000. The reason is that the scatter of a molecular weight of the polymer to be crosslinked is small, as described later.

The molecular weight distribution (Mw/Mn) of the polymer (A) is preferably 1 to 3.5, more preferably 1.2 to 3.5, still more preferably 1.5 to 2.5. Since the polymer (A) having Mw/Mn in the above range has a uniform molecular weight and contains a small amount of a low-molecular weight component, the resulting crosslinked product exhibits excellent heat resistance, and besides, staining on an adherend attributable to a low-molecular weight component can be suppressed when a pressure-sensitive adhesive sheet is removed under the conditions from low temperature to high temperature.

The polymer (A) is preferably a polymer obtained by polymerizing a vinyl monomer such as a (meth)acrylic ester onto a compound represented by the formula (A1) (also referred to as a “compound (A1)” hereinafter) through a RAFT polymerization method.

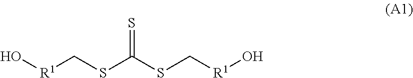

In the formula (A1), each R¹ is independently a divalent organic group.

The compound (A1) has a trithiocarbonate structure at the center of a molecule or in the vicinity of the center thereof, and has hydroxyl groups at both ends of a molecule. The compound (A1) can be synthesized in accordance with, for example, the process described in Japanese Patent Laid-Open Publication No. 2007-230947. By the use of the compound (A1) having the above structure, a telechelic structure can be formed without containing a harmful organic metal.

By carrying out RAFT polymerization, a highly symmetric chain polymer can be obtained, wherein repeating structural units derived from a vinyl monomer are bonded almost equally on both sides of the trithiocarbonate structure present at the center of a molecule or in the vicinity of the center thereof, and hydroxyl groups are bonded to both ends of a molecule.

The compound (A1) is, for example, a compound represented by the formula (A2) (also referred to as a “compound (A2)” hereinafter) or a compound represented by the formula (A3) (also referred to as a “compound (A3)” hereinafter).

The compound (A2) has a trithiocarbonate structure at the center of a molecule or in the vicinity of the center thereof, and has one hydroxyl group at each end of a molecule. As the compound (A2), RAFT-NT manufactured by Nippon Terpene Chemicals, Inc. can be mentioned.

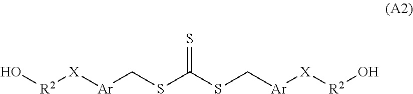

In the formula (A2), each X is independently —COO—, —CONR³— or a direct bond, each R³ is independently an alkyl group, the number of carbon atoms of the alkyl group is preferably 1 to 4, more preferably 1 to 3; each R² is independently an alkylene group, the number of carbon atoms of the alkylene group is preferably 1 to 4, more preferably 1 to 3; and each Ar is independently a phenylene group, a naphthylene group or a group wherein at least one of aromatic ring hydrogen atoms contained in a phenylene group or a naphthylene group is substituted by a substituent. Examples of the substituents include an alkyl group and an alkoxy group. In X, the carbonyl group in —COO— and —CONR³— is bonded to Ar. Two X are preferably the same groups; two R² are preferably the same groups; two R³ are preferably the same groups; and two Ar are preferably the same groups.

The compound (A3) has a trithiocarbonate structure at the center of a molecule or in the vicinity of the center thereof, and has two hydroxyl groups at each end of a molecule. As the compound (A3), RAFT-DiOH manufactured by Nippon Terpene Chemicals, Inc. can be mentioned.

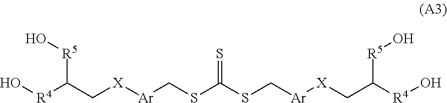

In the formula (A3), X and Ar have the same meanings as those of the same symbols in the formula (A2); each R⁴ is independently an alkylene group, each R⁵ is independently a direct bond or an alkylene group, and the number of carbon atoms of these alkylene groups is preferably 1 to 4, more preferably 1 to 3. Two X are preferably the same groups; two R⁴ are preferably the same groups; two R⁵ are preferably the same groups; and two Ar are preferably the same groups.

Specific examples of the compounds (A1) are shown below.

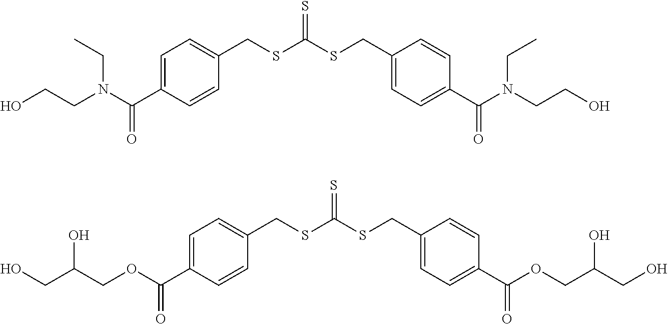 [SMILES: CCN(CCO)C(=O)c1ccc(CSC(=S)SCc2ccc(C(=O)N(CC)CCO)cc2)cc1 ; O=C(OCC(O)CO)c1ccc(CSC(=S)SCc2ccc(C(=O)OCC(O)CO)cc2)cc1]

In the RAFT polymerization, one or more vinyl monomers are polymerized in the presence of the compound (A1). The amount of the compound (A1) used is usually 0.05 to 20 parts by mass, preferably 0.05 to 10 parts by mass, based on 100 parts by mass of the total amount of the vinyl monomers. When the amount of the compound (A1) used is not less than the lower limit of the above range, reaction control is easy, and when the amount thereof is not more than the upper limit of the above range, it is easy to adjust the weight-average molecular weight of the resulting polymer to the above range.

For example, the reaction is carried out in such a manner that the vinyl monomer is inserted between a sulfur atom in the compound (A1) and a methylene group adjacent to the sulfur atom to form a polymer represented by the formula (A1-1) (also referred to as a “polymer (A1-1)” hereinafter), such as a polymer represented by the formula (A2-1) or the formula (A3-1) (also referred to as a “polymer (A2-1)” or a “polymer (A3-1)” hereinafter).

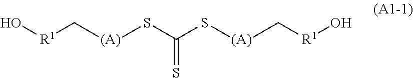

In the formula (A1-1), R¹ has the same meaning as that of the same symbol in the formula (A1), each (A) is independently a divalent group derived from a polymer comprising a vinyl monomer (polymer chain comprising vinyl monomer), and at least a part of the vinyl monomer is a (meth)acrylic ester.

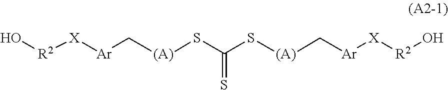

In the formula (A2-1), X, R² and Ar have the same meanings as those of the same symbols in the formula (A2), each (A) is independently a divalent group derived from a polymer comprising a vinyl monomer (polymer chain comprising vinyl monomer), and at least a part of the vinyl monomer is a (meth)acrylic ester.

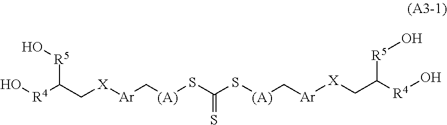

In the formula (A3-1), X, R⁴, R⁵ and Ar have the same meanings as those of the same symbols in the formula (A3), each (A) is independently a divalent group derived from a polymer comprising a vinyl monomer (polymer chain comprising vinyl monomer), and at least a part of the vinyl monomer is a (meth)acrylic ester.

The A (divalent group derived from polymer) in the formulas (A1-1) to (A3-1) may have any of a homopolymer structure of a vinyl monomer and a copolymer structure thereof, and the copolymer structure may be any of a random copolymer structure of a vinyl monomer and a block copolymer structure thereof.

In the A (divalent group derived from polymer) in the formulas (A1-1) to (A3-1), the number of repeating structural units derived from a vinyl monomer is such a number that Mw of the polymer (A) becomes within the above range, and is, for example, 400 to 3,600, preferably 500 to 3,400, more preferably 700 to 3,000.

The block copolymer structure can be obtained by, for example, adding a vinyl monomer to the compound (A1) to carry out first RAFT polymerization and adding an additional vinyl monomer to the resulting polymer to carry out second RAFT polymerization. Here, an example of a two-component system block structure is given, but the block copolymer structure may be a three-component system block structure or the like and is not specifically restricted. For example, a polymer represented by the formula (A1-2) (also referred to as a “polymer (A1-2)” hereinafter), such as a polymer represented by the formula (A2-2) or the formula (A3-2) (also referred to as a “polymer (A2-2)” or a “polymer (A3-2)” hereinafter), can be mentioned.

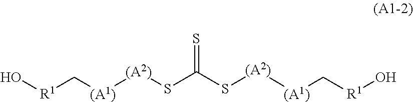

In the formula (A1-2), R¹ has the same meaning as that of the same symbol in the formula (A1), (A¹) and (A²) are each independently a divalent group derived from a polymer comprising a vinyl monomer (polymer chain comprising vinyl monomer), and at least a part of the vinyl monomer is a (meth)acrylic ester.

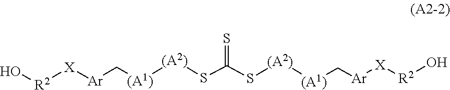

In the formula (A2-2), X, R² and Ar have the same meanings as those of the same symbols in the formula (A2), (A¹) and (A²) are each independently a divalent group derived from a polymer comprising a vinyl monomer (polymer chain comprising vinyl monomer), and at least a part of the vinyl monomer is a (meth)acrylic ester.

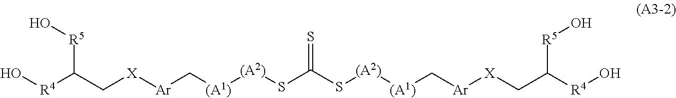

In the formula (A3-2), X, R⁴, R⁵ and Ar have the same meanings as those of the same symbols in the formula (A3), (A¹) and (A²) are each independently a divalent group derived from a polymer comprising a vinyl monomer (polymer chain comprising vinyl monomer), and at least a part of the vinyl monomer is a (meth)acrylic ester.

In the A¹ and the A² (each being divalent group derived from polymer) in the formulas (A1-2) to (A3-2), the number of repeating structural units derived from a vinyl monomer is preferably 1 to 3559, more preferably 1 to 3399, still more preferably 1 to 2999.

When a polymer in which a polymer chain comprising a vinyl monomer has a block copolymer structure, such as any of the polymers (A1-2) to (A3-2), is used as the polymer (A), the resulting composition for a pressure-sensitive adhesive is well-balanced in hydrophobicity-hydrophilicity, flexibility-rigidity, etc. according to the purpose.

The (meth)acrylic ester polymer obtained by living polymerizing a (meth)acrylic ester through the RAFT polymerization method in the presence of the compound (A1) is straight-chain and has hydroxyl groups at both ends of a molecule. According to the living polymerization by the RAFT polymerization method, the molecular weight distribution is narrower and the amount of a low-molecular weight component is smaller as compared with radical polymerization by the conventional free radical polymerization method, and therefore, staining on an adherend attributable to a low-molecular weight component in the removal of a pressure-sensitive adhesive sheet can be suppressed.

The RAFT polymer having the above structure has a soft segment derived from a polymer chain comprising a vinyl monomer. Hence, it is thought that the isocyanate group of the polyfunctional isocyanate compound tends to come close to the end hydroxyl group of the RAFT polymer, so that formation of urethane bond efficiently proceeds.

The polymer (A) can be used singly or in combination of two or more kinds.

The content of the (meth)acrylic ester polymer (A) in the composition for a pressure-sensitive adhesive is usually 80 to 99% by mass, more preferably 85 to 96% by mass, particularly preferably 90 to 93% by mass, in 100% by mass of the solids content of the composition, except the solvent. When the content of the polymer (A) is in the above range, a balance of properties of a pressure-sensitive adhesive is kept, and the adhesion properties are excellent.

<<Vinyl Monomer>>

In the RAFT polymerization method, at least a (meth)acrylic ester is used as the vinyl monomer. In addition, functional group-containing monomers and other copolymerizable monomers can be used.

<(Meth)Acrylic Ester>

Examples of the (meth)acrylic esters include alkyl (meth)acrylates, alkoxyalkyl (meth)acrylates, alkoxypolyalkylene glycol mono(meth)acrylates, and alicyclic group-containing or aromatic ring-containing (meth)acrylates. However, from the (meth)acrylic esters, functional group-containing (meth)acrylates, such as carboxyl group-containing (meth)acrylates, hydroxyl group-containing (meth)acrylates and amino group-containing (meth)acrylates, are excluded.

The number of carbon atoms of the alkyl group in the alkyl (meth)acrylates is preferably 1 to 20. Examples of the alkyl (meth)acrylates include methyl(meth)acrylate, ethyl(meth)acrylate, n-propyl (meth)acrylate, isopropyl (meth)acrylate, n-butyl (meth)acrylate, isobutyl(meth)acrylate, tert-butyl(meth)acrylate, pentyl (meth)acrylate, hexyl (meth)acrylate, heptyl (meth)acrylate, 2-ethylhexyl (meth)acrylate, octyl (meth)acrylate, nonyl (meth)acrylate, decyl (meth)acrylate, undeca (meth)acrylate, lauryl (meth)acrylate, oleyl (meth)acrylate, n-stearyl (meth)acrylate, isostearyl (meth)acrylate and dideca (meth)acrylate.

Examples of the alkoxyalkyl (meth)acrylates include methoxymethyl (meth)acrylate, 2-methoxyethyl (meth)acrylate, 2-ethoxyethyl (meth)acrylate, 3-methoxypropyl (meth)acrylate, 3-ethoxypropyl (meth)acrylate, 4-methoxybutyl (meth)acrylate and 4-ethoxybutyl (meth)acrylate.

Examples of the alkoxypolyalkylene glycol mono (meth)acrylates include methoxydiethylene glycol mono(meth)acrylate, methoxydipropylene glycol mono(meth)acrylate, ethoxytriethylene glycol mono(meth)acrylate, ethoxydiethylene glycol mono(meth)acrylate and methoxytriethylene glycol mono(meth)acrylate.

Examples of the alicyclic group-containing or aromatic ring-containing (meth)acrylates include cyclohexyl (meth)acrylate, benzyl (meth)acrylate and phenyl (meth)acrylate.

The (meth)acrylic esters can be used singly or in combination of two or more kinds.

The amount of the (meth)acrylic ester used in the RAFT polymerization method is usually not less than 70% by mass, preferably not less than 80% by mass, more preferably not less than 90% by mass, based on 100% by mass of all of the vinyl monomers.

When a block copolymer structure is formed in the RAFT polymerization method, it is preferable to select different two kinds from the (meth)acrylic esters as vinyl monomers for forming, for example, each of the A¹ and the A² in the polymers (A1-2) to (A3-2).

<Functional Group-Containing Monomer>

The functional group-containing monomer is, for example, an acid group-containing monomer, a hydroxyl group-containing monomer, an amino group-containing monomer, an amide group-containing monomer, a nitrogen-based heterocyclic ring-containing monomer or a cyano group-containing monomer. The acid group is, for example, a carboxyl group, an acid anhydride group, a phosphoric acid group or a sulfuric acid group.

Examples of the carboxyl group-containing monomers include carboxyl group-containing (meth)acrylates, such as β-carboxyethyl (meth)acrylate, 5-carboxypentyl (meth)acrylate, succinic acid mono(meth)acryloyloxyethyl ester and ω-carboxypolycaprolactone mono(meth)acrylate; acrylic acid, methacrylic acid, itaconic acid, crotonic acid, fumaric acid and maleic acid. Examples of the acid anhydride group-containing monomers include phthalic acid, maleic anhydride and succinic acid. Examples of the phosphoric acid group-containing monomers include (meth)acrylic monomers having a phosphoric acid group on the side chain. Examples of the sulfuric acid group-containing monomers include (meth)acrylic monomers having a sulfuric acid group on the side chain.

Examples of the hydroxyl group-containing monomers include hydroxyl group-containing (meth)acrylates, such as 2-hydroxyethyl (meth)acrylate, 3-hydroxypropyl (meth)acrylate, 4-hydroxybutyl (meth)acrylate, 6-hydroxyhexyl (meth)acrylate and 8-hydroxyoctyl (meth)acrylate.

Examples of the amino group-containing monomers include amino group-containing (meth)acrylates, such as dimethylaminoethyl (meth)acrylate and diethylaminoethyl (meth)acrylate.

Examples of the amide group-containing monomers include (meth)acrylamide, N-methyl(meth)acrylamide, N-ethyl(meth)acrylamide, N-propyl(meth)acrylamide and N-hexyl(meth)acrylamide. Examples of the nitrogen-based heterocyclic ring-containing monomers include vinylpyrrolidone, acryloylmorpholine and vinylcaprolactam. Examples of the cyano group-containing monomers include cyano(meth)acrylate and (meth)acrylonitrile.

In the synthesis of the polymer (A), the total amount of all of the functional group-containing monomers used is preferably 0 to 10% by mass based on the total mass of all of the monomers to constitute the polymer (A). In the case of a copolymer comprising a monomer containing a functional group having reactivity to isocyanate group, such as hydroxyl group or amino group, however, the molecular weight between crosslinking points becomes heterogeneous by the isocyanate crosslinking, and therefore, the amount of the monomer component containing a functional group having reactivity to the isocyanate group is suitably not more than 0.1% by mass.

The functional group-containing monomers can be used singly or in combination of two or more kinds.

<Copolymerizable Monomer>

Examples of the copolymerizable monomers include styrene-based monomers, e.g., styrene, alkylstyrenes such as methylstyrene, dimethylstyrene, trimethylstyrene, propylstyrene, butylstyrene, hexylstyrene, heptylstyrene and octylstyrene, fluorostyrene, chlorostyrene, bromostyrene, dibromostyrene, iodostyrene, nitrostyrene, acetylstyrene and methoxystyene, and vinyl acetate.

The copolymerizable monomers can be used singly or in combination of two or more kinds.

<Polymerization Initiator>

In the RAFT polymerization method, polymerization can be carried out by merely heating in the absence of a polymerization initiator, but it is preferably carried out in the presence of a polymerization initiator. The polymerization initiator is, for example, a usual inorganic polymerization initiator and/or a usual organic polymerization initiator, and specifically, there can be mentioned persulfates such as potassium persulfate and ammonium persulfate, peroxides such as benzoyl peroxide and laurium peroxide, and azo compounds such as 2,2′-asobisisobutyronitrile. Of these, azo compounds are preferable.

Examples of the azo compounds include 2,2′-azobisisobutyronitrile, 2,2′-azobis(4-methoxy-2,4-dimethylvaleronitrile), 2,2′-azobis(2-cyclopropylpropionitrile), 2,2′-azobis(2,4-dimethylvaleronitrile), 2,2′-azobis(2-methylbutyronitrile), 1,1′-azobis(cyclohexane-1-carbonitrile), 2-(carbamoylazo)isobutyronitrile, 2-phenylazo-4-methoxy-2,4-dimethylvaleronitrile, 2,2′-azobis(2-amidinopropane)dihydrochloride, 2,2′-azobis(N,N′-dimethyleneisobutylamidine), 2,2′-azobis[2-methyl-N-(2-hydroxyethyl)-propionamide], 2,2′-azobis(isobutylamido)dehydrate, 4,4′-azobis(4-cyanopentanoic acid), 2,2′-azobis(2-cyanopropanol), dimethyl-2,2′-azobis(2-methylpropionate) and 2,2′-azobis[2-methyl-N-(2-hydroxyethyl)propionamide].

The polymerization initiators can be used singly or in combination of two or more kinds.

The amount of the polymerization initiator used is usually 0.001 to 2 parts by mass, preferably 0.002 to 1 part by mass, based on 100 parts by mass of the vinyl monomer.

<<Polymerization Conditions>>

In the RAFT polymerization method, the reaction temperature is usually 60 to 120° C., preferably 80 to 110° C., and the reaction is carried out usually in an atmosphere of an inert gas such as nitrogen gas. This reaction can be carried out under any conditions of normal pressure, applied pressure and reduced pressure, and is usually carried out at normal pressure. The reaction time is usually 1 to 14 hours, preferably 2 to 8 hours. With regard to the polymerization conditions, for example, Japanese Patent Laid-Open Publication No. 2007-230947 and Japanese Patent Laid-Open Publication No. 2011-52057 can be referred to.

The reaction of the RAFT polymerization is usually carried out without using a reaction solvent, but if necessary, a reaction solvent may be used. Examples of the reaction solvents include aromatic hydrocarbons, such as benzene, toluene and xylene; aliphatic hydrocarbons, such as n-pentane, n-hexane, n-heptane and n-octane; alicyclic hydrocarbons, such as cyclopentane, cyclohexane, cycloheptane and cyclooctane; ethers, such as diethyl ether, diisopropyl ether, 1,2-dimethoxyethane, dibutyl ether, tetrahydrofuran, dioxane, anisole, phenyl ethyl ether and diphenyl ether; halogenated hydrocarbons, such as chloroform, carbon tetrachloride, 1,2-dichloroethane and chlorobenzene; esters, such as ethyl acetate, propyl acetate, butyl acetate and methyl propionate; ketones, such as acetone, methyl ethyl ketone, diethyl ketone, methyl isobutyl ketone and cyclohexanone; amides, such as N,N-dimethylformamide, N, N-dimethylacetamide and N-methylpyrrolidone; nitriles, such as acetonitrile and benzonitrile; and sulfoxides, such as dimethyl sulfoxide and sulfolane. These solvents can be used singly or in combination of two or more kinds.

<Polyfunctional Isocyanate Compound (B)>

As the polyfunctional isocyanate compound (B), one or more compounds selected from isocynate compounds having an average number of isocyanate groups in one molecule being more than 2 can be used. By crosslinking the polymer (A) with the compound (B), a crosslinked product (network polymer) can be formed. The above isocyanate compounds have low toxicity and are excellent in safety.

As the polyfunctional isocyanate compound (B), a compound usually having a weight-average molecular weight (Mw) of 200 to 2,000, particularly 350 to 1,000, is preferably used. A crosslinking agent having Mw of not less than 350 exhibits low volatility, and therefore, odors derived from the crosslinking agent can be reduced.

Examples of the polyfunctional isocyanate compounds (B) include a multimer of a bi- or higher functional isocyanate compound (e.g., dimer or trimer, isocyanurate body), a derivative thereof (e.g., addition reaction product of polyhydric alcohol and bi- or higher molecular bifunctional isocyanate), and a polymerization product thereof. Further, aromatic polyisocyanate, aliphatic polyisocyanate and alicyclic isocyanate, each having a number of isocyanate groups being 3 or more, can be also mentioned.

Examples of the bifunctional isocyanate compounds in the above multimers, the above derivates and the above polymerization products include aliphatic diisocyanates of 4 to 30 carbon atoms, such as ethylene diisocyanate, tetramethylene diisocyanate, pentamethylene diisocyanate, hexamethylene diisocyanate, 2-methyl-1,5-pentane diisocyanate, 3-methyl-1,5-pentane diisocyanate and 2,2,4-trimethyl-1,6-hexamethylene diisocyanate; alicyclic diisocyanates of 7 to 30 carbon atoms, such as isophorone diisocyanate, cyclopentyl diisocyanate, cyclohexyl diisocyanate, hydrogenated xylylene diisocyanate, hydrogenated tolylene diisocyanate, hydrogenated diphenylmethane diisocyanate and hydrogenated tetramethylxylene diisocyanate; and aromatic diisocyanates of 8 to 30 carbon atoms, such as phenylene diisocyanate, tolylenediisocyanate, xylylene diisocyanate, naphthylene diisocyanate, diphenyl ether diisocyanate, diphenylmethane diisocyanate and diphenylpropane diisocyanate.

Examples of the polyhydric alcohols in the above derivatives include low-molecular weight polyhydric alcohols, e.g., tri- or higher hydric alcohols such as trimethylolpropane, glycerol and pentaerythritol; and high-molecular weight polyhydric alcohols, such as polyether polyol and polyester polyol.

More specifically, there can be mentioned a dimer or a trimer of diphenylmethane diisocyanate, an isocyanurate body of hexamethylene diisocyanate (trimer adduct of isocyanurate structure), a reaction product of trimethylolpropane and tolylene diisocyanate, a reaction product of trimethylolpropane and hexamethylene diisocyanate, polymethylene polyphenyl isocyanate, polyether polyisocyanate, polyester polyisocyanate, 2,4,6-triisocyanate toluene, 1,3,5-triisocyanate benzene, and 4,4′,4″-triphenylmethane triisocyanate.

Examples of commercial products of the polyfunctional isocyanate compounds (B) include “L-45” (trade name) manufactured by Soken Chemical & Engineering Co., Ltd., “Duranate TPA-100” (trade name) manufactured by Asahi Kasei Chemicals Corporation, and “Coronate L”, “Coronate HL”, “Coronate HK”, “Coronate HX”, “Coronate 2096” and “Millionate MR200” (trade names) manufactured by Nippon Polyurethane Industry Co., Ltd.

The average number of isocyanate groups of the polyfunctional isocyanate compound (B) means the number of isocyanate groups in one molecule statistically possessed by the isocyanate compound. A calculation method for the average number of functional groups is disclosed in Japanese Patent Laid-Open Publication 1998-231347, and is based on the following formula.

Average number of isocyanate groups=number-average molecular weight of isocyanate compound×isocyanate group weight concentration/formula weight of isocyanate group(42)

In the above formula, the isocyanate group weight concentration is a weight of isocyanate groups (formula weight: 42) contained in 1 g of the isocyanate compound.

Also the number-average molecular weight and the weight-average molecular weight of the isocyanate compound can be measured based on the method disclosed in Japanese Patent Laid-Open Publication 1998-231347.

When the polyfunctional isocyanate compound (B) is a single compound, the average number of isocyanate groups means the number of isocyanate groups plainly possessed by the polyfunctional isocyanate compound (B).

The average number of isocyanate functional groups of the polyfunctional isocyanate compound (B) is more than 2, preferably not less than 2.3, more preferably 2.3 to 4.0, still more preferably 2.3 to 3.5. It is preferable that the average number of isocyanate groups is in the above range because flexibility of the pressure-sensitive adhesive is maintained.

The content of the polyfunctional isocyanate compound (B) in the composition for a pressure-sensitive adhesive is in such a range that the total amount of isocyanate groups of the compound (B) based on 1 mol of an end hydroxyl group of the polymer (A) usually becomes 1 to 100 mol, preferably 10 to 90 mol, more preferably 20 to 80 mol. When the content of the compound (B) is in such a range as above, cohesion properties of the resulting composition are not lowered, and the resulting composition is excellent in balance of adhesion properties. Particularly when the compound (B) is used in an amount of not less than the above lower limit, the rate of reaction between the end hydroxyl group and the isocyanate group is enhanced. If the content is less than the above lower limit, curing is insufficiently carried out, and adhesion performance is not developed in some cases.

To the composition of the present invention, an isocyanate compound having an average number of isocyanate groups being not more than 2 may be added in addition to the polyfunctional isocyanate compound (B), within limits that do not impair balance of adhesion properties. Examples of the compounds having an average number of isocyanate groups being not more than 2 include aromatic diisocyanate, aliphatic diisocyanate and alicyclic diisocyanate. The isocyanate compound having an average number of isocyanate groups being not more than 2 is preferably used in an amount of such a range that the total amount of isocyanate groups of the compound becomes 0.01 to 100 mol based on 1 mol of an end hydroxyl group of the polymer (A).

<Additives>

The composition for a pressure-sensitive adhesive of the present invention may further contain, in addition to the above components, one or more additives selected from an organic solvent, an antistatic agent, an ultraviolet absorbing agent, an antioxidant, a tackifying resin, a plasticizer, an anti-foaming agent, a filler, a stabilizer, a softener and a wettability controlling agent, within limits that do not impair transparency, visibility and effects of the present invention.

As the organic solvent, a reaction solvent described in the paragraph of <<Polymerization conditions>> of RAFT polymerization can be used. For example, by mixing a polymer solution containing the (meth)acrylic ester polymer (A) and a reaction solvent, the solution having been obtained by RAFT polymerization, with the polyfucntional isocyanate compound (B), a composition for a pressure-sensitive adhesive can be prepared. In the composition for a pressure-sensitive adhesive of the present invention, the content of the organic solvent is usually 0 to 90% by mass, preferably 10 to 80% by mass.

[Pressure-Sensitive Adhesive]

The pressure-sensitive adhesive of the present invention is obtained by crosslinking the above-mentioned composition for an pressure-sensitive adhesive, specifically, by crosslinking the (meth)acrylic ester polymer (A) with the polyfunctional isocyanate compound (B). The pressure-sensitive adhesive thus obtained has conventional basic properties, such as adhesive strength, holding power and constant load properties, and has excellent functions such that the degree of staining on an adherend in the removal of a pressure-sensitive adhesive sheet is low and dependence of peel force on peel rate and dependence of peel force on peeling temperature are small.

The conditions for forming the pressure-sensitive adhesive are as follows. For example, the above composition is applied onto a support and dried usually at 60 to 120° C., preferably 70 to 110° C., usually for 1 to 5 minutes, preferably 2 to 4 minutes, to form a coating film.

The pressure-sensitive adhesive is preferably formed under the following conditions. The composition is applied onto a support, then onto the coating film formed under the above conditions, a cover film is applied, and thereafter, curing is carried out in an environment usually at 5 to 60° C., preferably 15 to 40° C., and usually at 30 to 70% RH, preferably 40 to 70% RH, usually for not shorter than 3 days, preferably 7 to 10 days. When crosslinking is carried out under such aging conditions as above, efficient formation of a crosslinked product (network polymer) is possible.

Examples of the supports and the cover films include films made of plastics such as polyester, polyethylene, polypropylene and ethylene/vinyl acetate copolymer, specifically a polyethylene terephthalate film and the like.

[Pressure-Sensitive Adhesive Sheet]

The pressure-sensitive adhesive sheet of the present invention has a substrate and a pressure-sensitive adhesive layer formed of the aforesaid composition for a pressure-sensitive adhesive. This pressure-sensitive adhesive sheet may have a protective film on the pressure-sensitive adhesive layer.

The thickness of the pressure-sensitive adhesive layer is usually 3 to 100 μm, preferably 5 to 50 μm. Although the thickness of each of the substrate and the protective film is not specifically restricted, it is usually 10 to 100 μm, preferably 25 to 50 μm.

Examples of the substrates and the protective films include films made of plastics such as polyester, polyethylene, polypropylene and ethylene/vinyl acetate copolymer, specifically a polyethylene terephthalate film and the like.

The pressure-sensitive adhesive sheet of the present invention has a good balance of adhesion properties, and has a feature that when the pressure-sensitive adhesive sheet is applied to an adherend and then removed, staining on the adherend is low. Moreover, there is no large difference in peel force between a case of removing the pressure-sensitive adhesive sheet at a low speed and a case of removing it at a high speed, and even at a constant speed or at a variable speed, application and removal of the pressure-sensitive adhesive sheet can be carried out with an almost constant force.

When the pressure-sensitive adhesive sheet of the present invention is applied to an adherend and then removed, there is no large difference in peel force between a case of removing the pressure-sensitive adhesive sheet in a high-temperature environment and a case of removing it in a low-temperature environment, and application and removal of the pressure-sensitive adhesive sheet can be carried out with an almost constant force without depending on the temperature.

Accordingly, the pressure-sensitive adhesive sheet of the present invention can be widely used as an industrial pressure-sensitive adhesive sheet, and it can be used particularly for a removable or optical protective film.

### Examples

The present invention is further described with reference to the following examples, but it should be construed that the present invention is in no way limited to those examples. In the following description of the examples, etc., “part(s)” means “part(s) by mass” unless otherwise noted.

The measured values in the examples are those determined by the following methods.

[(Meth)Acrylic Ester Polymer]

### 1. Molecular Weight and Molecular Weight Distribution

Weight-average molecular weight (Mw) and number-average molecular weight (Mn) of the (meth)acrylic ester polymer, in terms of standard polystyrene, were determined by gel permeation chromatography (GPC) under the following conditions.
Measuring device: HLC-8120GPC (manufactured by Tosoh Corporation)
GPC column constitution: following 5 columns (all manufactured by Tosoh Corporation)
(1) TSK-GEL HXL-H (guard column)
(2) TSK-GEL G7000HXL
(3) TSK-GEL GMHXL
(4) TSK-GEL GMHXL
(5) TSK-GEL G2500HXL
Sample concentration: The sample was diluted to 1.0 mg/cm³ with tetrahydrofuran.
Mobile phase solvent: tetrahydrofuran
Flow rate: 1.0 cm³/min
Column temperature: 40° C.

### 2. Viscosity Measurement

A 500 ml bottle containing varnish was immersed in a constant-temperature water bath at 25° C. and allowed to stand still for 12 hours. Thereafter, with regard to a solution containing each (meth)acrylic ester polymer obtained in the examples, etc., viscosity was measured in accordance with the measuring method using a B-type viscometer.

### 3. Nonvolatile Content Measurement

In a tinplate Petri dish (n1) precisely weighed, 1 g of an acrylic polymer solution was placed, then the total weight (n2) was precisely measured, and thereafter, the Petri dish was heated at 105° C. for 3 hours. Thereafter, the tinplate Petri dish was allowed to stand still for 1 hour in a desiccator at room temperature, then it was precisely weighed again to measure the total weight (n3) after heating. Using the resulting measured weight values (n1 to n3), a nonvolatile content was calculated from the following formula.

Nonvolatile content (%)=100×[weight after heating (n3−n1)/weight before heating (n2−n1)]

### 4. Preparation of (Meth)Acrylic Ester Polymer

### Preparation Example 1

In a flask equipped with a stirring device, a nitrogen gas feed pipe, a thermometer and a reflux condenser tube, 100 parts of n-butyl acrylate and 0.08 part of bis[4-{ethyl-(2-hydroxyethyl)aminocarbonyl}-benzyl]trithiocarbon ate represented by the following formula (manufactured by Nippon Terpene Chemicals, Inc.) (also referred to as “RAFT agent-1” hereinafter) were placed, and while introducing nitrogen gas into the flask, the contents in the flask were heated to 80° C.

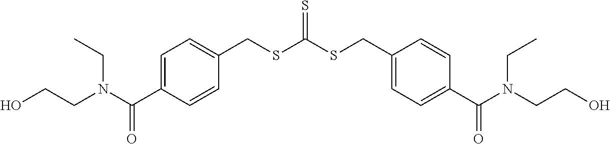 [SMILES: CCN(CCO)C(=O)c1ccc(CSC(=S)SCc2ccc(C(=O)N(CC)CCO)cc2)cc1]

Subsequently, 0.02 part of 2,2′-azobisisobutyronitrile (also referred to as “AIBN” hereinafter) was added into the flask while stirring the contents, and heating and cooling were carried out for 1 hour in such a manner that the temperature of the contents in the flask could be maintained at 80° C. Subsequently, 80 parts of ethyl acetate were dropwise added over a period of 1 hour while maintaining the temperature of the contents in the flask at 80° C. Also after that, heating and cooling were carried out for 10 hours in such a manner that the temperature of the contents in the flask could be maintained at 80° C., and finally, 20 parts of ethyl acetate were added.

Thus, a polymer solution containing an acrylic polymer (1) was obtained.

The molecular weights of the acrylic polymer (1) contained in the resulting polymer solution, as measured by GPC, were Mn: 88,000, Mw: 220,000 and Mw/Mn: 2.5. The viscosity of the resulting polymer solution at 25° C. was 6.1 Pa·s, and the nonvolatile content was 50.1% by mass.

### Preparation Examples 2, 4, 5 and 6, Comparative Preparation Example 3

A polymer solution containing an acrylic polymer (2), (4), (5) or (6) or an acrylic polymer (c3) was obtained in the same manner as in Preparation Example 1, except that the type and the amount of the monomer and the type and the amount of the RAFT agent were changed as described in Table 1.

The RAFT agent-2 is represented by the following formula.

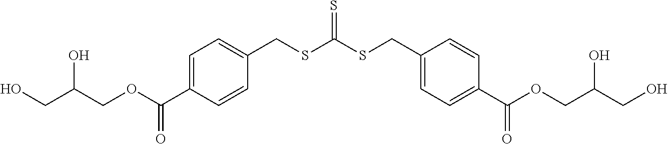 [SMILES: O=C(OCC(O)CO)c1ccc(CSC(=S)SCc2ccc(C(=O)OCC(O)CO)cc2)cc1]

### Preparation Example 3

In a flask equipped with a stirring device, a nitrogen gas feed pipe, a thermometer and a reflux condenser tube, 17 parts of methyl acrylate and 0.08 part of the RAFT agent-1 were placed, and while introducing nitrogen gas into the flask, the contents in the flask were heated to 80° C.

Subsequently, 0.02 part of AIBN was added into the flask while stirring the contents, and heating and cooling were carried out for 2 hours in such a manner that the temperature of the contents in the flask could be maintained at 80° C. The nonvolatile content of the thus obtained acrylic polymer was 99.5% by mass.

Subsequently, a mixed liquid of 83 parts of n-butyl acrylate and 80 parts of ethyl acetate was dropwise added over a period of 1 hour while maintaining the temperature of the contents in the flask at 80° C. Also after that, heating and cooling were carried out for 9 hours in such a manner that the temperature of the contents in the flask could be maintained at 80° C., and finally, 20 parts of ethyl acetate were added.

Thus, a polymer solution containing an acrylic polymer (3) was obtained.

### Comparative Preparation Example 1 Free Radical Polymerization

In a flask equipped with a stirring device, a nitrogen gas feed pipe, a thermometer and a reflux condenser tube, 99.86 parts of n-butyl acrylate, 0.14 part of 2-hydroxyethyl acrylate, 0.15 part of N-dodecylmercaptan and 77 parts of ethyl acetate were placed, and while introducing nitrogen gas into the flask, the contents in the flask were heated to 66 to 67° C. Subsequently, 0.1 part of dimethyl-2,2′-azobis(2-methylpropionate) (V-601, manufactured by Wako Pure Chemical Industries, Ltd.) was added into the flask while stirring the contents. Then, heating and cooling were carried out for 4 hours in such a manner that the temperature of the contents in the flask could be maintained at 66 to 67° C. Thus, a polymer solution containing an acrylic polymer (c1) was obtained.

### Comparative Preparation Example 2

In a flask equipped with a stirring device, a nitrogen gas feed pipe, a thermometer and a reflux condenser tube, 100 parts of n-butyl acrylate and 2 parts of the aforesaid RAFT agent-1 were placed, and while introducing nitrogen gas into the flask, the contents in the flask were heated to 80° C. Subsequently, 0.03 part of AIBN was added into the flask while stirring the contents, then heating and cooling were carried out for 4 hours in such a manner that the temperature of the contents in the flask could be maintained at 80° C., and finally, 25 parts of ethyl acetate were added. Thus, a polymer solution containing an acrylic polymer (c2) was obtained.

Evaluation results of the acrylic polymers are set forth in Table 1.

TABLE 1

| | | | Prep. | Prep. | Prep. | Prep. | Prep. |
|---|---|---|---|---|---|---|---|
| | | | Ex. 1 | Ex. 2 | Ex. 3 | Ex. 4 | Ex. 5 |
| Acrylic polymer No. | | | (1) | (2) | (3) | (4) | (5) |
| Polymerization | Monomer | n-Butyl acrylate | 100 | | 83 | 100 | 96 |
| conditions | composition | 2-Ethylhexyl acrylate | | 100 | | | |
| | | Methyl acrylate | | | 17 | | |
| | | Acrylic acid | | | | | 4 |
| | | 2-Hydroxyethyl | | | | | |
| | | acrylate | | | | | |

| | | | | | |
|---|---|---|---|---|---|
| RAFT agent-1 *1 | 0.08 | 0.08 | 0.08 | 0.50 | 0.08 |
| RAFT agent-2 *2 | | | | | |
| Ethyl acetate | 100 | 100 | 100 | 100 | 100 |

| | | | | | | |
|---|---|---|---|---|---|---|
| Polymer properties | Trithiocarbonate | yes | yes | yes | yes | yes |
| | structure | | | | | |
| | Mn | 88,000 | 83,000 | 88,000 | 47,000 | 100,000 |
| | Mw | 220,000 | 250,000 | 230,000 | 70,000 | 250,000 |
| | Mw/Mn | 2.5 | 3.0 | 2.6 | 1.5 | 2.5 |
| | Viscosity at 25° C. | 6.1 | 10.4 | 8.2 | 4.5 | 29.0 |
| | (Pa · s) | | | | | |
| | Nonvolatile content | 50.1 | 48.8 | 49.8 | 50.6 | 51.9 |
| | (% by mass) | | | | | |

| | | | | Comp. | Comp. | Comp. |
|---|---|---|---|---|---|---|
| | | | Prep. | Prep. | Prep. | Prep. |
| | | | Ex. 6 | Ex. 1 | Ex. 2 | Ex. 3 |
| Acrylic polymer No. | | | (6) | (c1) | (c2) | (c3) |
| Polymerization | Monomer | n-Butyl acrylate | 100 | 99.86 | 100 | 100 |
| conditions | composition | 2-Ethylhexyl acrylate | | | | |
| | | Methyl acrylate | | | | |
| | | Acrylic acid | | | | |
| | | 2-Hydroxyethyl | | 0.14 | | |
| | | acrylate | | | | |

| | | | | |
|---|---|---|---|---|
| RAFT agent-1 *1 | | | 2 | 0.04 |
| RAFT agent-2 *2 | 0.08 | | | |
| Ethyl acetate | 100 | 77 | 25 | 100 |

| | | | | | |
|---|---|---|---|---|---|
| Polymer properties | Trithiocarbonate | yes | no | yes | yes |
| | structure | | | | |
| | Mn | 92,000 | 28,000 | 17,000 | 114,000 |
| | Mw | 230,000 | 200,000 | 20,000 | 400,000 |
| | Mw/Mn | 2.5 | 5.2 | 1.2 | 3.5 |
| | Viscosity at 25° C. | 6.7 | 9.5 | 4.1 | 32.0 |
| | (Pa · s) | | | | |
| | Nonvolatile content | 50.3 | 53.3 | 79.8 | 48.8 |
| | (% by mass) | | | | |

*1 RAFT agent-1: bis[4-{ethyl-(2-hydroxyethyl)aminocarbonyl}-benzyl]trithiocarbonate (manufactured by Nippon Terpene Chemicals, Inc.)
*2 RAFT agent-2 (manufactured by Nippon Terpene Chemicals, Inc.)

### Example 1

The polymer solution containing the acrylic polymer (1) obtained in Preparation Example 1 and L-45 (manufactured by Soken Chemical & Engineering Co., Ltd.) as an isocyanate compound were mixed in such a ratio (solids content ratio) that the amount of L-45 compounded based on 100 parts of the acrylic polymer (1) became 9 parts, whereby a composition for a pressure-sensitive adhesive was obtained. This compounding ratio was designed in such a manner that the total amount of isocyanate groups of the isocyanate compound became 50 mol based on 1 mol of the number of end hydroxyl groups of the acrylic polymer (1).

After defoaming, the composition for a pressure-sensitive adhesive was applied to a polyethylene terephthalate (PET) separator (trade name: Cerapeel MFA, manufactured by Toray Advanced Film Co., Ltd.) by the use of a doctor blade in such a manner that the dry film thickness became 25 μm, and the composition was immediately dried at 80° C. for 3 minutes to form a coating film on the PET separator. After the above drying, to a surface of the thus formed coating film, the surface being on the opposite side to the PET separator, a PET film having a thickness of 25 μm was applied, and they were allowed to stand still for 7 days under the conditions of room temperature 23° C. and a humidity of 65% to obtain a pressure-sensitive adhesive sheet consisting of PET separator/pressure-sensitive adhesive layer/PET film.

### Examples 2 to 6 Comparative Examples 1 to 4

Compositions for pressure-sensitive adhesives and pressure-sensitive adhesive sheets were obtained in the same manner as in Example 1, except that the types and the amounts of the acrylic polymer and the isocyanate compound compounded were changed as described in Table 2.

[Pressure-Sensitive Adhesive Sheet]

<1. Peel Force (N/25 mm)>

The PET film of each pressure-sensitive adhesive sheet obtained in the examples, etc. was peeled under the conditions of 23° C. and 50% RH, and to the exposed surface of the pressure-sensitive adhesive layer, a SUS plate was applied under pressure by the use of a roller of 2 kg. 20 Minutes after the application, the pressure-sensitive adhesive sheet was peeled from the SUS plate at a peel rate of 50 mm/min, 300 mm/min or 1000 mm/min under the conditions of 25° C. and a peel angle of 180° to measure a peel force (adhesive strength) of the pressure-sensitive adhesive layer of the pressure-sensitive adhesive sheet. In the case of peeling of the pressure-sensitive adhesive sheet at a peel rate of 300 mm/min, the peeling was carried out under the conditions of 40° C., 25° C. and 5° C.

<2. Holding Power Test>

The PET film of each pressure-sensitive adhesive sheet obtained in the examples, etc. was peeled under the conditions of 23° C. and 50% RH, and to the exposed surface of the pressure-sensitive adhesive layer, a SUS plate was applied under pressure by the use of a roller of 2 kg. The application area was 20 mm×20 mm. 20 Minutes after the application, a load of 1 kg was applied at 40° C. under the drying conditions, and after 1 hour, a distance of deviation from the original position was measured. When the test specimen fell from the SUS plate within the measurement time, the time required for falling was measured. A case where the specimen fell is described as “fall”.

<3. Constant Load Test>

The PET film of each pressure-sensitive adhesive sheet obtained in the examples, etc. was peeled under the conditions of 23° C. and 50% RH, and to the exposed surface of the pressure-sensitive adhesive layer, a SUS plate was applied under pressure by the use of a roller of 2 kg. The application area was 20 mm (width)×40 mm. 20 Minutes after the application, a load of 100 g was applied in the direction of 90° at 40° C. under the drying conditions, and after 60 minutes, a peeling length (mm) was measured. When the test specimen fell from the SUS plate within the measurement time, the time required for falling was measured. A case where the specimen fell is described as “fall”.

<4. Heat Resistance Test>

The PET film of each pressure-sensitive adhesive sheet obtained in the examples, etc. was peeled under the conditions of 23° C. and 50% RH, and to the exposed surface of the pressure-sensitive adhesive layer, a SUS plate was applied under pressure by the use of a roller of 2 kg. 20 Minutes after the application, they were allowed to stand still for 6 hours at 150° C. under the drying conditions. Further, they were allowed to stand still for 20 minutes under the conditions of 23° C. and 50% RH, and thereafter, the pressure-sensitive adhesive sheet was peeled from the SUS plate at a peel rate of 300 mm/min under the conditions of 25° C. and a peel angle of 180° to measure a peel force (adhesive strength) of the pressure-sensitive adhesive layer of the pressure-sensitive adhesive sheet. After the peeling, the state of the adherend was visually observed.

TABLE 2

| | | | | | | | | Comp. | Comp. | Comp. | Comp. |
|---|---|---|---|---|---|---|---|---|---|---|---|
| | | Ex. 1 | Ex. 2 | Ex. 3 | Ex. 4 | Ex. 5 | Ex. 6 | Ex. 1 | Ex. 2 | Ex. 3 | Ex. 4 |
| Acrylic polymer | (1) | 100 | | | | | | | | | 100 |
| (parts(s) by | (2) | | 100 | | | | | | | | |
| mass) | (3) | | | 100 | | | | | | | |
| | (4) | | | | 100 | | | | | | |
| | (5) | | | | | 100 | | | | | |
| | (6) | | | | | | 100 | | | | |
| | (c1) | | | | | | | 100 | | | |
| | (c2) | | | | | | | | 100 | | |
| | (c3) | | | | | | | | | 100 | |
| Isocyanate | L-45 (TDI-based adduct) | 9 | | 1 | 22 | 9 | 9 | 9 | 40 | 4 | |
| compound | Duranate TPA-100 (HDI-based nurate) | | 5 | | | | | | | | |
| (part(s) by | Millionate MR200 | | | 6 | | | | | | | |
| mass) | (urethane-modified polymeric MDI) | | | | | | | | | | |
| | Duranate D201 | | | | | | | | | | 8 |
| | (HDI-based bifunctional isocyanate) | | | | | | | | | | |
| NCO/OH | | 50 | 30 | 40 | 40 | 50 | 50 | 50 | 20 | 40 | 40 |
| (molar ratio) | | | | | | | | | | | |
| Adhesion | Low-speed peel force (N/25 mm): | 9.5 | 3.2 | 8.2 | 4.9 | 10.5 | 9.0 | 10.3 | 7.0 | 15.9 | 10.2 |
| properties | 50 mm/min | | | | | | | | | | |
| | Standard peel force (N/25 mm): | 9.0 | 3.0 | 8.0 | 6.0 | 10.7 | 8.2 | 12.0 | 5.2 | 14.7 | 5.5 |
| | 300 mm/min | | | | | | | | | | |
| | High-speed peel force (N/25 mm): | 8.5 | 3.4 | 7.6 | 7.1 | 11.0 | 7.8 | 14.7 | 3.0 | 12.1 | 2.7 |
| | 1000 mm/min | | | | | | | | | | |
| | Low-speed peel force/high-speed peel | 1.1 | 0.9 | 1.1 | 0.7 | 1.0 | 1.2 | 0.7 | 2.3 | 1.3 | 3.8 |
| | force | | | | | | | | | | |
| | High-temperature peel force | 9.5 | 3.4 | 8.8 | 6.6 | 11.0 | 9.1 | 16.6 | 7.3 | 17.6 | 2.1 |
| | (N/25 mm): 40° C. | | | | | | | | | | |
| | Standlard peel force (N/25 mm): 25° C. | 9.0 | 3.0 | 8.0 | 6.0 | 10.7 | 8.2 | 12.0 | 5.2 | 14.7 | 5.5 |
| | Low-temperature peel force (N/25 mm): | 8.7 | 2.8 | 7.6 | 5.4 | 10.1 | 7.9 | 10.2 | 3.1 | 11.3 | 7.6 |
| | 5° C. | | | | | | | | | | |
| | High-temperature peel | 1.1 | 1.2 | 1.2 | 1.2 | 1.1 | 1.2 | 1.6 | 2.4 | 1.6 | 0.3 |
| | force/low-temperature peel force | | | | | | | | | | |
| | Holding power test (mm): 40° C., 1 kg | 0 | 0 | 0 | 0 | 0 | 0 | 0 | 0 | fall: 20 min | fall: 38 min |
| | Constant load test (mm): 40° C., 100 g | 1 | 5 | 0 | 10 | 0 | 6 | fall: | fall: | fall: 45 min | fall: 44 min |
| | | | | | | | | 9 min | 12 min | | |
| Heat resistance | Adhesive strength (N/25 mm) | 11 | 5 | 10 | 8 | 12.6 | 10.5 | 17.1 | 12 | 5 | 2 |
| (150° C., after 6 | Peeling state | af | af | af | af | af | af | staining | staining | cf | cf |
| hours) | | | | | | | | | | | |

A peeling state of interfacial failure is described as “af”.
A peeling state of cohesive failure is described as “cf”.
A peeling state in which staining on an adherend is observed is described as “staining”.

The isocyanate compounds used in the examples, etc. are as follows. As the molecular weights of the isocyanate compounds, calculated values based on the structural formulas or catalog values are described here.

TABLE 3

| | | | Average | |
|---|---|---|---|---|
| | | | number of | |
| | | | isocyanate | |
| | | | functional | |
| Trade name | Manufacturer | Details | groups | Mw |
| L-45 | Soken | trimethylolpropane- | about 3 | 657 |
| | Chemical | modified tolylene | | |
| | & Engineering | diisocyanate | | |
| | Co., Ltd. | | | |
| Duranate | Asahi Kasei | hexamethylene | about 3 | 540 |
| TPA-100 | Chemicals | diisocyanate- | | |
| | Corporation | based nurate | | |
| Millionate | Nippon | urethane-modified | more than 2 | 430 |
| MR200 | Polyurethane | polymeric | but not more | |
| | Industry Co., | diphenylmethane | than 4 | |
| | Ltd. | diisocyanate | | |
| Duranate | Asahi Kasei | hexamethylene | about 2 | 550 |
| D201 | Chemicals | diisocyanate-based | | |
| | Corporation | bifunctional | | |
| | | isocyanate | | |

1. A composition for a pressure-sensitive adhesive, comprising:
(A) a (meth)acrylic ester polymer having a structure represented by the formula (a1), having hydroxyl groups at both ends of a molecule and having a weight-average molecular weight (Mw), as measured by gel permeation chromatography, of 50,000 to 300,000, and
(B) an isocyanate compound having an average number of isocyanate groups in one molecule being more than 2,

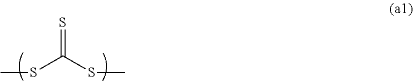

2. The composition for a pressure-sensitive adhesive as claimed in claim 1, wherein the molecular weight distribution (Mw/Mn) of the (meth)acrylic ester polymer (A) is 1 to 3.5.

3. The composition for a pressure-sensitive adhesive as claimed in claim 1, wherein the (meth)acrylic ester polymer (A) is a RAFT polymer represented by the formula (A1-1): 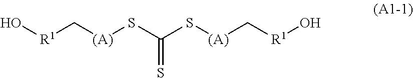
wherein each R¹ is independently a divalent organic group, and each (A) is independently a divalent group derived from a polymer comprising a vinyl monomer.

4. The composition for a pressure-sensitive adhesive as claimed in claim 1, wherein the (meth)acrylic ester polymer (A) is at least one kind selected from a RAFT polymer represented by the formula (A2-1) and a RAFT polymer represented by the formula (A3-1), 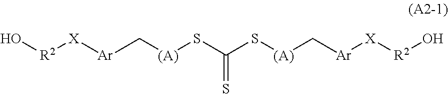
wherein each X is independently —COO—, —CONR³— or a direct bond, each R³ is independently an alkyl group; each R² is independently an alkylene group; each Ar is independently a phenylene group, a naphthylene group or a group wherein at least one of aromatic ring hydrogen atoms contained in a phenylene group or a naphthylene group is substituted by a substituent; and each (A) is independently a divalent group derived from a polymer comprising a vinyl monomer, 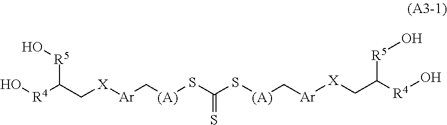
wherein each X is independently —COO—, —CONR³— or a direct bond, each R³ is independently an alkyl group; each R⁴ is independently an alkylene group; each R⁵ is independently a direct bond or an alkylene group; each Ar is independently a phenylene group, a naphthylene group or a group wherein at least one of aromatic ring hydrogen atoms contained in a phenylene group or a naphthylene group is substituted by a substituent; and each (A) is independently a divalent group derived from a polymer comprising a vinyl monomer.

5. The composition for a pressure-sensitive adhesive as claimed in claim 1, wherein the (meth)acrylic ester polymer (A) and the isocyanate compound (B) are contained in such amounts that the total amount of isocyanate groups of the compound (B) based on 1 mol of an end hydroxyl group of the polymer (A) becomes 1 to 100 mol.

6. A pressure-sensitive adhesive sheet having:
a substrate, and
a pressure-sensitive adhesive layer formed of the composition as claimed in claim 1.

7. The composition for a pressure-sensitive adhesive as claimed in claim 2, wherein the (meth)acrylic ester polymer (A) is a RAFT polymer represented by the formula (A1-1): 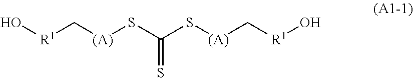
wherein each R¹ is independently a divalent organic group, and each (A) is independently a divalent group derived from a polymer comprising a vinyl monomer.

8. The composition for a pressure-sensitive adhesive as claimed in claim 2, wherein the (meth)acrylic ester polymer (A) is at least one kind selected from a RAFT polymer represented by the formula (A2-1) and a RAFT polymer represented by the formula (A3-1), 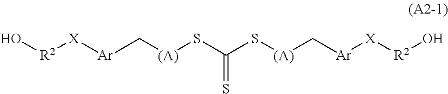
wherein each X is independently —COO—, —CONR³— or a direct bond, each R³ is independently an alkyl group; each R² is independently an alkylene group; each Ar is independently a phenylene group, a naphthylene group or a group wherein at least one of aromatic ring hydrogen atoms contained in a phenylene group or a naphthylene group is substituted by a substituent; and each (A) is independently a divalent group derived from a polymer comprising a vinyl monomer, 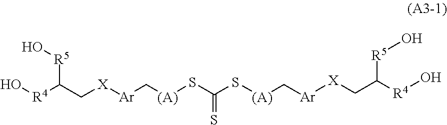
wherein each X is independently —COO—, —CONR³— or a direct bond, each R³ is independently an alkyl group; each R⁴ is independently an alkylene group; each R⁵ is independently a direct bond or an alkylene group; each Ar is independently a phenylene group, a naphthylene group or a group wherein at least one of aromatic ring hydrogen atoms contained in a phenylene group or a naphthylene group is substituted by a substituent; and each (A) is independently a divalent group derived from a polymer comprising a vinyl monomer.

9. The composition for a pressure-sensitive adhesive as claimed in claim 3, wherein the (meth)acrylic ester polymer (A) is at least one kind selected from a RAFT polymer represented by the formula (A2-1) and a RAFT polymer represented by the formula (A3-1), 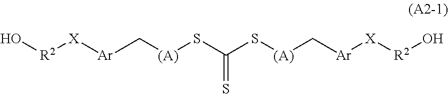
wherein each X is independently —COO—, —CONR³— or a direct bond, each R³ is independently an alkyl group; each R² is independently an alkylene group; each Ar is independently a phenylene group, a naphthylene group or a group wherein at least one of aromatic ring hydrogen atoms contained in a phenylene group or a naphthylene group is substituted by a substituent; and each (A) is independently a divalent group derived from a polymer comprising a vinyl monomer, 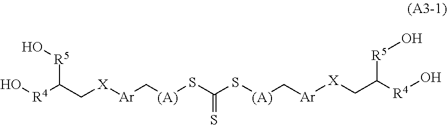
wherein each X is independently —COO—, —CONR³— or a direct bond, each R³ is independently an alkyl group; each R⁴ is independently an alkylene group; each R⁵ is independently a direct bond or an alkylene group; each Ar is independently a phenylene group, a naphthylene group or a group wherein at least one of aromatic ring hydrogen atoms contained in a phenylene group or a naphthylene group is substituted by a substituent; and each (A) is independently a divalent group derived from a polymer comprising a vinyl monomer.

10. The composition for a pressure-sensitive adhesive as claimed in claim 2, wherein the (meth)acrylic ester polymer (A) and the isocyanate compound (13) are contained in such amounts that the total amount of isocyanate groups of the compound (B) based on 1 mol of an end hydroxyl group of the polymer (A) becomes 1 to 100 mol.

11. The composition for a pressure-sensitive adhesive as claimed in claim 3, wherein the (meth)acrylic ester polymer (A) and the isocyanate compound (B) are contained in such amounts that the total amount of isocyanate groups of the compound (B) based on 1 mol of an end hydroxyl group of the polymer (A) becomes 1 to 100 mol.

12. The composition for a pressure-sensitive adhesive as claimed in claim 4, wherein the (meth)acrylic ester polymer (A) and the isocyanate compound (B) are contained in such amounts that the total amount of isocyanate groups of the compound (B) based on 1 mol of an end hydroxyl group of the polymer (A) becomes 1 to 100 mol.

13. A pressure-sensitive adhesive sheet having:
a substrate, and
a pressure-sensitive adhesive layer formed of the composition as claimed in claim 2.

14. A pressure-sensitive adhesive sheet having:
a substrate, and
a pressure-sensitive adhesive layer formed of the composition as claimed in claim 3.

15. A pressure-sensitive adhesive sheet having:
a substrate, and
a pressure-sensitive adhesive layer formed of the composition as claimed in claim 4.

16. A pressure-sensitive adhesive sheet having:
a substrate, and
a pressure-sensitive adhesive layer formed of the composition as claimed in claim 5.
